(19) United States
(12) Patent Application Publication
(10) Pub. No.: US 2014/0261225 A1
(43) Pub. Date: Sep. 18, 2014

(54) PET GROOMING AND DEMATTING TOOL

(71) Applicant: Christina J. Lee, Port St Lucie, FL (US)

(72) Inventor: Christina J. Lee, Port St Lucie, FL (US)

(21) Appl. No.: 13/826,360

(22) Filed: Mar. 14, 2013

(51) Int. Cl. A01K 13/00

(52) U.S. Cl. CPC A01K 13/002
USPC 119/625

(57) ABSTRACT

The invention provides a device for dematting hair or fur. The device comprises a handle portion for a user to hold and a comb or top portion having a plurality of teeth or tines arranged in at least one row. The plurality of tines are formed as substantially flat members with a broader base portion and tapering to a pointed tip portion. The plurality of tines are separated from one another by a predetermined distance, and have a twist adjacent the base portion.

### TECHNICAL FIELD

The present invention generally relates to an apparatus and methods for grooming animals, and in particular to devices and methods for dematting or untangling animal hair and fur.

### BACKGROUND OF THE INVENTION

Long-haired dogs and other hair-bearing animals tend to form mats in their hair if not regularly groomed. Matting occurs when the animal's coat collects dirt, dander, oil or other materials, and tangles with the longer hairs to product the mat. This mat is often difficult to detangle, and therefore many times is simply removed by cutting it out of the animal's coat. This can involve cutting off the matted hair at the coat base.

There have been developed a variety of products for the purpose of grooming pets, including dematting combs, which have a plurality of dematting blades with sharp, sometimes serrated edges, for cutting through matted hair or fur. Though effective at cutting out matted fur, the use of dematting combs cuts the mat from the animal's coat, which is undesirable, and can result in injury to the animal or even the user.

It would be desirable to have a device for dematting animal hair without cutting off the matted hair and subjecting animals to sharp blades.

### BRIEF SUMMARY OF THE INVENTION

The present invention provides a device for dematting hair or fur. The device comprises a handle portion for a user to hold and a comb or top portion having a plurality of teeth or tines arranged in at least one row. The plurality of tines are formed as substantially flat members with a broader base portion and tapering to a pointed tip portion. The configuration of the tines may be as an isosceles triangle with a short base portion, and equal length sides extending from the base. The base portion of the tines are positioned along the axis of the handle portion. The tines are formed with edges that are not designed to cut the fur or hair, and may be slightly rounded or squared so as not to cut the hair or fur. The plurality of tines are separated from one another by a predetermined distance, and have a twist adjacent the base portion. In an example, the twist is about ninety degrees and is formed near the base portion, such that the tip portion extends at a substantially ninety degree position relative to the axis of the handle. Further rows of a plurality of tines may be provided.

The dematting tool is held by the handle portion, which may be ergonomically designed, and the tines are pulled through the animal's or person's matted hair in a direction parallel to the natural lie of the hair and away from the skin. The twisting action of the plurality of teeth or tines cause the hairs in the mat to lift and separate from each other and break free from one another as the tool is moved through the mat. Repeating this general motion will cause the mat to completely break apart without the need to cut out any of the animal's coat.

### BRIEF DESCRIPTION OF SEVERAL VIEWS OF THE DRAWINGS

FIG. 1 is side view of the apparatus according to the present invention.

FIG. 2 is a front view illustrating the ergonomic handle grip and its position for the user's hand, as well as an axial view of the plurality of twisted teeth, in accordance with the present invention.

FIG. 3 is a top view of the apparatus viewed axially through the length of the handle according to the present invention.

FIG. 4 is a close-up view of the twisted design of the individual teeth, each one rotated ninety degrees according to the present invention.

FIG. 5 is a perspective view of the apparatus held by a user according to the present invention.

FIG. 6 is a view of an alternate example of the invention.

FIG. 7 is an alternative embodiment with two sets of a plurality of twisted teeth at the head of the tool and an ergonomically designed handle according to the present invention.

### DETAILED DESCRIPTION OF THE INVENTION

FIGS. 1-3 illustrate an example of dematting tool 10 according to the present invention, comprising an elongated longitudinal top portion 20, and an ergonomic handle 30. On the top portion 20, at least one row of a plurality of tines 40 are positioned. The tines 40 may be formed as a separate member or members assembled with the top portion 20, or integrally with top portion 20. The tines 40 are aligned along the axis of the handle 30 and comb or top portion 20. In an example, the tines 40 are formed of a strong material such as metal, but may be formed of any suitable material. The tines 40 project outward from the top portion 20 a predetermined distance, such as between ¼ to five inches for most animals, but any suitable length may be used. The tool 10 may be of any suitable length, such as between about six to twelve inches.

As seen in FIG. 4, the plurality of tines 40 are formed as substantially flat members having a predetermined thickness, such as between 0.02 to 0.2, with thicknesses of between about 0.05 and 0.1 inches suitable for many animals. Each tine 40 has a base portion 42 and tapers to a pointed tip portion 44. The configuration of the tines 40 may be as an isosceles triangle with a bottom side 46 having a predetermined length, and equal length sides 48 extending outwardly from the base side 46 and top portion 20. The length of the base portion 46 may be between about 0.05 to 0.2 inches, with a length of between about 0.1 to 0.15 inches suitable for many animals. The length of the tines extending outwardly from the top portion 20 may be between 0.2 to. It should be recognized that dimensions of the invention may vary depending on the type of application. The base portion 46 of the tines 40 are substantially aligned with the axis of the handle 30 and top portion 20. The tines are formed with edges that are not designed to cut the fur or hair, and may be slightly rounded or squared so as not to cut the hair or fur. The tines then twist or are rotated adjacent the base portion 46 at 50. In an example, the twist 50 is about ninety degrees and is formed near the base portion 46, such that the tip portion 44 extends at a substantially ninety degree position relative to the axis of the top portion 20 and handle 30. At the tip portion 44, the plurality of tines 40 are separated from one another by a predetermined distance, such as between 0.05 and 1 inch, and for many animals, between about 0.1 and 0.4 inches. The tip portion 44 of each tine may be blunted or rounded off so as to reduce the likelihood of accidentally injuring the animal.

As seen in FIG. 5, this example of the invention is suitable for removing mats of hair when the tines 40 are placed in contact with or near the animal's skin and drawn through its hair parallel to the natural lie of the hair. The twist 50 in the tines 40 cause a twisting action in the engaged hair, such that as the tool is moved through the hair, the plurality of teeth or tines 40 cause the hairs in the mat to lift and separate from each other, and to break free from one another as the tool 10 is moved through the mat. As the width of the tines 40 increases along the length until twist 50 is engaged, the hair is automatically separated as it moves toward the end or base 46 of the tine 40. The hair then engages the progressively rotating twist 50, to be moved and separated as the tines enter the animal's section of matted hair. The passing of each tine first causes the matted hair to separate into horizontally parallel strips between the tines. As the tines 40 move through the hair, the rotation of each tine then causes the matted strips to separate vertically, further dividing each matted strip. Repeated motions with the tool 10 cause the strips of matted hair to get smaller until the entire mat is broken apart in a gentle and effective manner. In use, as the user passes the tool through the hair in the direction of the lay, each tine 40 separates the hair and additional passes cause separation of the mat and combing the long hairs without undue tension, so they are not pulled out at the roots or broken. The attached short hair is also combed. The design of the teeth or tines presents a smooth, non-cutting edge to the animal's skin while minimizing hair pull. Both the animal's comfort and the required grooming time are improved substantially when compared to standard grooming practice, and the hair is not cut or substantially damaged.

FIG. 6 illustrates an alternative example of tool 100 that comprises an elongated longitudinal shaft 120 and comb portion 140, with a plurality of twisted tines 150. Encapsulating the handle portion of the shaft is a textured grip 160 used to handle the tool. This grip 160 represents an alternative feature to the ergonomic handle of the previous example.

FIG. 7 illustrates an additional alternative example of tool 200 that comprises an elongated longitudinal top portion 220, an ergonomic handle 230, and a comb portion 240. The comb portion 240 comprises multiple rows 244 of a plurality of twisted teeth or tines 250. The rows of teeth or tines may be positioned in a staggered manner to further aid in the dematting of the animal's coat. Further rows of a plurality of tines may be provided.

In the examples, the teeth or tines can be made of any material having sufficient hardness to put some force on the hair without breaking, such as metal, plastic, wood, and/or other materials. In particular, teeth or tines should be strong enough to withstand the force imparted as they move forward while they are placed in matted animal hair.

Numerous modifications to and alternative embodiments of the present invention will be apparent to those skilled in the art in view of the foregoing description. Accordingly, this description is to be construed as illustrative only and is for the purpose of teaching those skilled in the art the best mode of carrying out the invention. Details of the embodiment may be varied without departing from the spirit of the invention, and the exclusive use of all modifications which come within the scope of the appended claims is reserved.

What is claimed is:

1. A tool for dematting hair, comprising:
a handle portion and a top portion having an axis;
a plurality of tines aligned in a row along the axis of the handle and top portion, with a first end of each tine adjacent the top portion and extending to a second end positioned outwardly of the handle portion, and wherein each tine is twisted about ninety degrees adjacent the first end.

2. The tool according to claim 1, wherein the tines taper from the first end to the second end.

3. The tool according to claim 1, wherein the tines are formed in a substantially isosceles triangular shape, with the second end formed into a point.

4. The tool according to claim 3, wherein the point is blunted or rounded off.

5. The tool according to claim 1, wherein the tines are formed with edges that are not designed to cut the hair.

6. The tool according to claim 1, wherein the tines are formed with edges that are rounded or squared.

7. The tool according to claim 1, wherein the second end of the tines are separated from one another by about 0.1 and 0.4 inches.

8. The tool according to claim 1, wherein a plurality of rows of tines are provided aligned along the axis of the handle and top portion.

9. The tool according to claim 8, wherein the rows of tines are positioned adjacent one another.

10. The tool according to claim 9, wherein the rows of tines are staggered relative to one another such that adjacent tines are offset from one another.

11. A method of dematting hair comprising the steps of:
passing a plurality of teeth through the portion of matted hair, the teeth being separated to cause the matted hair to be divided into a series of parallel strips without any cutting of the matted hair, and the teeth having a twist to cause separation of the parallel strips of matted hair in the direction of the top portion of the tines, and repeating movement through the matted hair.

12. The method of claim 1 wherein the passing of the tool is made in the direction of the lay of the hair.
